(19) United States
(12) Patent Application Publication
(10) Pub. No.: US 2022/0410389 A1
(43) Pub. Date: Dec. 29, 2022

(54) ROBOT SYSTEM AND ERRONEOUS WIRING DETECTION METHOD THEREOF

(71) Applicant: NIDEC SANKYO CORPORATION, Nagano (JP)

(72) Inventor: Hiroaki NAGATA, Nagano (JP)

(21) Appl. No.: 17/839,485

(22) Filed: Jun. 14, 2022

(30) Foreign Application Priority Data
Jun. 25, 2021 (JP) 2021-105744

(51) Int. Cl. B25J 9/16

(52) U.S. Cl. CPC B25J 9/1653

(57) ABSTRACT

A robot system includes a manipulator having a plurality of axes and driven by a motor provided for each axis, a robot controller, an encoder attached to the motor for each axis, an encoder wiring line connecting the encoder with the robot controller, a storage part in the manipulator which stores mechanical parameters including identification information for discriminating the encoder for each axis, and a control part in the robot controller which reads out the mechanical parameters from the storage part and communicates with the encoder through the encoder wiring line. The control part discriminates whether the identification information read out from the encoder and the identification information included in the mechanical parameters are coincided with each other or not for each axis and, when both the identification informations are not coincided with each other, the control part determines that erroneous wiring exists in the encoder wiring line.

### CROSS REFERENCE TO RELATED APPLICATION

The present invention claims priority under 35 U.S.C. § 119 to Japanese Application No. 2021-105744 filed Jun. 25, 2021, the entire content of which is incorporated herein by reference.

### TECHNICAL FIELD

At least an embodiment of the present invention may relate to a robot system including a manipulator and a robot controller which controls operation of the manipulator. Specifically, at least an embodiment of the present invention may relate to a robot system which is capable of detecting erroneous wiring in encoder wiring of the robot system and to an erroneous wiring detection method thereof.

### BACKGROUND

A robot system includes a manipulator and a robot controller which controls the manipulator, and a hand or a tool is attached to the manipulator. An arm and a link are mutually connected with each other in the manipulator, and motors are provided for driving the arm and the link. An encoder for detecting a rotation position of a motor is attached to the motor. When the robot controller controls the manipulator, a motor is servo-controlled based on a motor position detected by the encoder. In order to perform servo control, a control circuit, for example, a servo driver is provided in the robot controller for each motor. A manipulator is commonly provided with a plurality of motors, and a control circuit in the robot controller and a motor and an encoder in the manipulator are required to be electrically connected with each other in a predetermined one-to-one relationship. For example, a first control circuit in the robot controller is required to be electrically connected with a first motor and a first encoder in the manipulator. In this case, when the first control circuit in the robot controller is connected with a second motor and a third encoder in the manipulator, the state is erroneous wiring. The erroneous wiring is also referred to as erroneous connection. In a case that erroneous wiring exists in a wiring line of an encoder, for example, when a certain motor is to be driven, the control is performed based on a rotation amount of a motor which is different from the corresponding motor and thus, the robot is operated so as to perform different movement from control to be intended. This causes a problem in securing safety. Conventionally, it is confirmed whether wiring is properly connected or not by visual observation during assembly of a manipulator or in maintenance of the manipulator.

When attention is paid to wiring between a robot controller and respective encoders provided in a manipulator, one assembled wiring member in which all wiring lines are bundled or a multi-core cable can be used between the robot controller and the manipulator and thus, in this case, erroneous wiring is relatively difficult to occur. Further, the manipulator is provided with a wiring circuit board (also referred to as a manipulator circuit board) or wiring line terminals with which the assembled wiring member or the multi-core cable from the robot controller is connected, and signal wiring lines (for example, a signal cable) for each encoder are provided from the wiring circuit board or wiring line terminals to each encoder. In a case that signal wiring lines are arranged as described above, erroneous connection of the signal wiring lines with the wiring circuit board or the wiring line terminals may easily occur and erroneous wiring is easy to occur. In a large-sized manipulator, signal wiring lines are sometimes extended by inserting a relay connector and erroneous connection may occur in the relay connector. Specifically, a signal wiring line for an encoder is a signal line or a signal cable whose diameter is small, and a connector which is used for connection of the signal wiring line is also small and thus, false recognition may easily occur when correctness of the connection in a wiring line is confirmed by visual observation, and possibility that erroneous wiring occurs becomes high. Erroneous wiring in encoder wiring may occur at a time of manufacturing or assembling of a manipulator and, in addition, may also occur when a wiring line is detached or a wiring line is inserted into and pulled out from a connector for maintenance of the manipulator.

International Publication No. 2012/172647 (Patent Literature 1) discloses that, as a method for detecting erroneous wiring in one of wiring for a motor and wiring for an encoder, erroneous wiring is detected by determining whether detected results in encoders of respective motors when a plurality of motors is sequentially driven are previously expected results or not. In Japanese Patent Laid-Open No. Hei 4-279906 (Patent Literature 2), a method is disclosed which detects erroneous wiring in an encoder having UVW-phase outputs and AB-phase outputs by a similar technique. International Publication No. 2014/181438 (Patent Literature 3) discloses that, when a motor is three-phase synchronous motor, erroneous wiring in one of wiring for a motor and wiring for an encoder is detected by comparing a position of a magnetic pole obtained by a drive current to the motor with an output of the encoder.

As a technique relating to an embodiment of the present invention, there is a technique which determines whether a combination of a robot controller with a manipulator (robot main body) is correct or not. Japanese Patent Laid-Open No. 2007-164398 (Patent Literature 4) and Japanese Patent Laid-Open No. 2007-152510 (Patent Literature 5) disclose a technique in which, when a manipulator is connected with a robot controller, the robot controller reads out type information or an identification label from a motor or an encoder in the manipulator and it is determined whether a combination of the robot controller and the manipulator is correct or not by comparing them with type information or an identification label which is previously stored in the robot controller.

As an encoder which is attached to a motor in a manipulator, in recent years, an encoder has been used which is capable of transmitting rotation position information of a motor between a robot controller and the encoder by bidirectional serial data communication. Such an encoder is provided with a nonvolatile memory and is capable of memorizing various information in addition to an identification label of the encoder. Japanese Patent Laid-Open No. 2019-107727 (Patent Literature 6) discloses a technique in which, in order to easily replace and connect the same model or a different model of a manipulator with a robot controller regardless of a model of the manipulator, a host device is provided which stores model configuration information for respective models of manipulators, and an encoder of a manipulator stores device specific data. The device specific data include information relating to an axis to which a corresponding encoder is attached and information of a model of the manipulator and the production number. In the robot controller, when it is detected that a model of the manipulator has been changed, the robot controller reads out model configuration information corresponding to a model after changed from a host computer and reads out device specific data from each encoder of the manipulator, and the robot controller controls the manipulator based on the model configuration information and the device specific data having been read out. Japanese Patent Laid-Open No. 2020-179486 (Patent Literature 7) also discloses a technique in which information relating to a model and a production number of a manipulator and information relating to an axis to which an encoder is attached are stored in a storage area of the encoder of the manipulator, and the robot controller is configured to read out the information and thereby, the robot controller or the like can be replaced and connected with the manipulator.

As a technique for detecting erroneous wiring in wiring lines which connect a robot controller with motors or encoders in a manipulator, the above-mentioned Patent Literatures 1 through 3 have been disclosed. In these Literatures, erroneous wiring is detected based on whether or not an expected signal is obtained from an encoder when each motor is driven and thus, a motor is required to be actually driven. From a viewpoint of securing safety, it is preferable that erroneous wiring relating to an encoder is detected without driving a motor.

### SUMMARY

In view of the problem described above, at least an embodiment of the present invention may advantageously provide a robot system capable of detecting erroneous wiring in wiring lines which connect a robot controller with encoders in a manipulator without driving a motor, and an erroneous wiring detection method thereof.

According to at least an embodiment of the present invention, there may be provided a robot system including a manipulator which has a plurality of axes and is driven by motors provided for each of the axes, a robot controller which controls the manipulator, an encoder which is attached to the motor for each of the axes, an encoder wiring line which is provided for each of the axes and connects the encoder with the robot controller, a storage part which is independently provided in the manipulator from the encoder and stores mechanical parameters including at least identification information for discriminating the encoder for each of the axes of the manipulator, and a control part which is provided in the robot controller and reads out the mechanical parameters from the storage part and communicates with the encoder through the encoder wiring line. The control part discriminates whether the identification information read out from the encoder through the encoder wiring line for discriminating the encoder and the identification information included in the mechanical parameters are coincided with each other or not for each of the axes and, when both the identification informations are not coincided with each other in at least one of the axes, the control part determines that erroneous wiring exists in the encoder wiring line.

As an encoder which is attached to a motor in a manipulator and detects a rotation position of the motor, an encoder has been commonly used which is connected with a robot controller by bidirectional serial communication. Such an encoder includes a nonvolatile memory, and identification information for discriminating the encoder, for example, a serial number is stored in the nonvolatile memory. In a robot system in accordance with an embodiment of the present invention, at a time of manufacturing a manipulator, for each axis of the manipulator, mechanical parameters including at least identification information of an encoder attached to an axis are previously stored in a storage part independently provided in the manipulator from the encoder. The identification information for each axis included in mechanical parameters correctly indicates identification information stored in an encoder provided in each axis of the manipulator. In the robot system in accordance with an embodiment of the present invention, a control part provided in the robot controller reads out identification information of an encoder from the encoder for each axis through an encoder wiring line to compare with identification information included in the mechanical parameters for each axis. When there is no erroneous wiring, the identification information which is read out from the encoder and the identification information included in the mechanical parameters are coincided with each other for all axes. On the other hand, when there is erroneous wiring, a connecting relationship of an encoder with a robot controller is different from correct connection. Specifically, when an encoder for a certain axis is connected with a robot controller as an encoder for an axis different from the intended axis, there exists an axis whose identification information read out from the encoder and the identification information included in the mechanical parameters are not coincided with each other. As a result, when there is an axis in which both identification informations are not coincided with each other, the control part determines that erroneous wiring has occurred in the encoder wiring line without actually driving a motor.

In the robot system in accordance with an embodiment of the present invention, it is preferable that the control part outputs information which identifies the encoder wiring line where the erroneous wiring has occurred based on an axis in which the identification information read out from the encoder and the identification information included in the mechanical parameters are not coincided with each other. When the above-mentioned information is outputted, the encoder wiring line of the axis is recognized where the erroneous wiring has actually occurred and thus, a load of work for searching for an actual erroneous wiring portion can be reduced remarkably.

In the robot system in accordance with an embodiment of the present invention, it may be configured that the mechanical parameters include configuration information relating to structure of the manipulator, and the robot controller controls the manipulator based on the configuration information extracted from the mechanical parameters which are read out by the control part. According to this structure, even if the robot controller does not previously store configuration information of the manipulator, when the robot controller connected with a manipulator has been changed, the robot system can be immediately operated.

Further, according to at least an embodiment of the present invention, there may be provided an erroneous wiring detection method of a robot system including a manipulator which has a plurality of axes and is driven by motors provided for each of the axes, a robot controller which controls the manipulator, and an encoder which is attached to the motor for each of the axes. The erroneous wiring detection method is a method for detecting erroneous wiring in an encoder wiring line which is provided for each of the axes and connects the encoder with the robot controller. The erroneous wiring detection method includes a storing step in which mechanical parameters including at least identification information for discriminating the encoder for each of the axes of the manipulator are previously stored in a storage part independently provided in the manipulator from the encoder, a discrimination step in which, in the robot controller, the identification information for discriminating the encoder is read out from the encoder of each of the axes through the encoder wiring line and the mechanical parameters are read out from the storage part to discriminate whether the identification information which is read out from the encoder and the identification information included in the mechanical parameters are coincided with each other or not for each of the axes, and an erroneous wiring detection step in which, both the identification informations are not coincided with each other in at least one of the axes in the discrimination step, it is determined that erroneous wiring exists in the encoder wiring line.

In the erroneous wiring detection method in accordance with an embodiment of the present invention, mechanical parameters including identification information (serial number or the like) of an encoder for each axis are previously stored in a storage part independently provided in the manipulator from the encoder. The identification information for each axis included in the mechanical parameters correctly indicates the identification information stored in the encoder which is provided in the each axis of the manipulator. Further, in the robot controller, it is discriminated whether the identification information which is read out from the encoder of each axis through the encoder wiring line and the identification information included in the mechanical parameters are coincided with each other or not for each axis. When there is erroneous wiring, an axis exists in which the identification information read out from the encoder and the identification information included in the mechanical parameters are not coincided with each other and thus, it is determined that the encoder wiring line has erroneous wiring without actually driving a motor.

In the erroneous wiring detection method in accordance with an embodiment of the present invention, it is preferable that, in the erroneous wiring detection step, information for identifying the encoder wiring line where the erroneous wiring has occurred is outputted based on an axis in which the identification information read out from the encoder and the identification information included in the mechanical parameters are not coincided with each other. When the above-mentioned information is outputted, the encoder wiring line of the axis where the erroneous wiring has actually occurred is recognized and thus, a load of work for searching for an actual erroneous wiring portion can be reduced remarkably.

In the erroneous wiring detection method in accordance with an embodiment of the present invention, it is preferable that the discrimination step and the erroneous wiring detection step are executed when the robot controller activates the manipulator. When the discrimination step and the erroneous wiring detection step are executed when the robot controller activates the manipulator, presence or absence of erroneous wiring is recognized before the robot controller actually operates the manipulator and thus, at a time of abnormality, the manipulator is not driven and occurrence of malfunction in the robot system is suppressed and safety is further improved.

In the erroneous wiring detection method in accordance with an embodiment of the present invention, it may be configured that the mechanical parameters include configuration information relating to configuration of the manipulator, and the configuration information extracted from the mechanical parameters is set to be a configuration information which is used when the robot controller controls the manipulator. According to this structure, the robot controller is not required to previously store configuration information of the manipulator and, when the robot controller connected with a manipulator has been changed, the robot system can be immediately operated

### Effects of the Invention

According to the present invention, in a robot system including a robot controller and a manipulator, erroneous wiring in a wiring line which connects the robot controller with an encoder in the manipulator can be detected without driving a motor in the manipulator.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing a configuration of a robot system in accordance with an embodiment of the present invention.

FIG. 2 is an explanatory flow chart showing processing for detecting erroneous wiring.

FIG. 3 is an explanatory flow chart showing another example of processing for detecting erroneous wiring.

### DETAILED DESCRIPTION

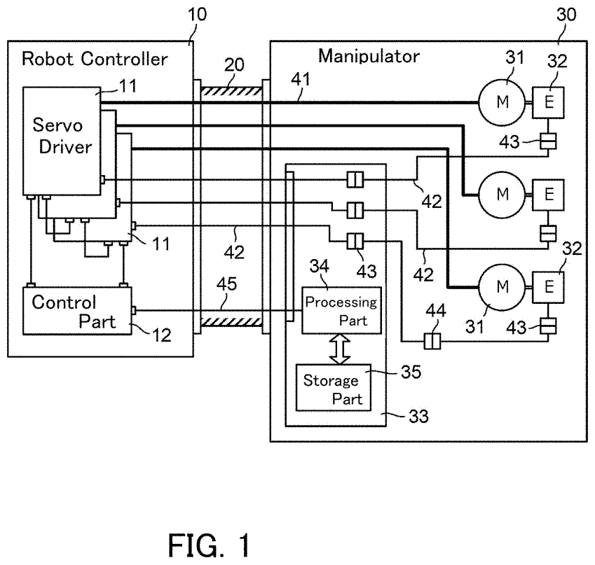

FIG. 1 shows a robot system in accordance with an embodiment of the present invention. The robot system includes a robot controller 10 and a manipulator 30, and the robot controller 10 and the manipulator 30 are electrically connected with each other through an aggregate wiring member 20. The manipulator 30 includes a plurality of axes, and a motor 31 is provided in each axis for driving the axis. The motor 31 is attached with an encoder 32 which detects a rotation position of the motor 31. The motor 31 is, for example, a three-phase synchronous motor. In the example shown for explanation, three motors 31 are provided in the manipulator 30. However, in a common manipulator, i.e., in a robot main body, the number of motors 31 provided in the manipulator is, for example, five through seven. Each encoder 32 is assigned with an identification information for uniquely identifying the individual encoder. The identification information is, for example, a serial number or a production number of the encoder 32.

The robot controller 10 is configured to control the manipulator 30 and includes a plurality of servo drivers 11 and a control part 12 which controls the whole of the robot controller 10. The servo driver 11 is provided so as to correspond to a motor 31 of each axis in the manipulator 30. For each axis of the manipulator 30, its rotation position information which is outputted from an encoder 32 connected with a motor 31 provided in the axis is supplied to a servo driver 11 provided for the axis, and the servo driver 11 for the axis drives the motor 31 of the axis based on the supplied rotation position information. The servo driver 11 for the axis and the motor 31 are connected with each other through a motor wiring line 41 for each axis, and the servo driver 11 for the axis and the encoder 32 are connected with each other through an encoder wiring line 42. The motor wiring line 41 is, for example, a power wiring line connected with coils of a three-phase synchronous motor, and the encoder wiring line 42 is a signal wiring line by bidirectional serial data communication. The servo driver 11 transmits a command to the encoder 32 at intervals of a constant time period and thereby acquires rotation position information of the corresponding motor 31 from the encoder 32. The control part 12 is, for example, configured of a microprocessor (MPU) and controls each servo driver 11 by high-speed serial communication (for example, CAN communication or Ether CAT (registered trademark) communication) which connects each servo driver 11 in a daisy chain mode. Therefore, the control part 12 is capable of communicating with the encoder 32 through the encoder wiring line 42 via the servo driver 11. Specifically, the control part 12 is capable of reading from the encoder 32 rotation position information of the corresponding motor 31 and identification information such as a serial number of the encoder 32 through the encoder wiring line 42 via the servo driver 11.

The manipulator 30 is provided with a manipulator circuit board 33 in addition to the motors 31 and encoders 32 for the respective axes. The manipulator circuit board 33 is provided with a processing part 34 which is, for example, configured of a microprocessor to communicate with the control part 12 in the robot controller 10 through a control data wiring line 45, and a storage part 35 which is configured of a nonvolatile memory and is connected with the processing part 34. In the control data wiring line 45, transmission and reception of a command and data are performed between the control part 12 and the processing part 34 by bidirectional serial data communication. Specifically, the control part 12 in the robot controller 10 transmits a command to the processing part 34 in the manipulator 30 through the control data wiring line 45 and instructs the processing part 34 to read data from the storage part 35 and thereby, the control part 12 is capable of reading out and acquiring mechanical parameters stored in the storage part 35. The processing part 34 and the storage part 35 may be, for example, integrated as one-chip microcomputer. Mechanical parameters of the manipulator 30 are written into the storage part 35 at a time of manufacturing of the manipulator 30. The mechanical parameters includes at least identification information of the encoder 32 for each axis of the manipulator 30 in order to indicate the axis to which the individual encoder 32 belongs. As described below, configuration information of the manipulator 30 may be included in the mechanical parameters.

The aggregate wiring member 20 electrically connecting the robot controller 10 with the manipulator 30 is, for example, a multi-core cable which is structured so that the motor wiring line 41 for each axis, the encoder wiring line 42 for each axis, and the control data wiring line 45 are bundled up as one piece, and the aggregate wiring member 20 is connected with each of the robot controller 10 and the manipulator 30 through a dedicated multi-core connector. The motor wiring line 41 which is a power wiring line may be provided between the robot controller 10 and the manipulator 30 through another cable instead of the aggregate wiring member 20. A power source is also required in the manipulator 30 for operating the encoders 32, the processing part 34 and the storage part 35, and a power source wiring line for operating them and a wiring line required to activate the manipulator 30 by the robot controller 10 are also provided between the robot controller 10 and the manipulator 30. These wiring lines may be also disposed in an inside of the aggregate wiring member 20.

In the manipulator 30, the multi-core connector which is used for connecting with the aggregate wiring member 30 is also connected with the manipulator circuit board 33 by a multi-core cable, and each encoder wiring line 42 and the control data wiring line 45 are connected and extended into the manipulator circuit board 33. The control data wiring line 45 is connected with the processing part 34 through a wiring pattern formed on the manipulator circuit board 33. Each encoder wiring line 42 is provided as a signal wiring line which is separately provided for each axis of the manipulator between the manipulator circuit board 33 and the encoder 32. A connector 43 is used for connection between the signal wiring line and the manipulator circuit board 33 and connection between the signal wiring line and the corresponding encoder 32. In order to pass a signal wiring line through a long link or a long arm in the manipulator 30, the signal wiring line may be extended through a relay connector 44. In these signal wiring lines, wiring members or cables of the same type are commonly used, and connectors of the same size and the same number of cores are used as the connector 43 and the relay connector 44. As a result, although erroneous wiring hardly occurs in the encoder wiring line 42 between the robot controller 10 and the manipulator circuit board 33, erroneous connection may easily occur in the connectors 43 and the relay connector 44 in a range between the manipulator circuit board 33 and the encoder 32 of each axis and thus, erroneous wiring easily occur in the encoder wiring line 42.

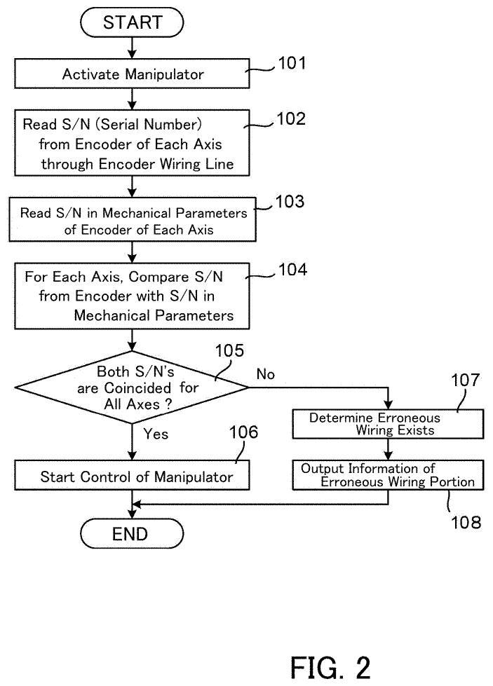

In order to prevent the above-mentioned problem, in the robot system in this embodiment, the control part 12 provided in the robot controller 10 is configured to automatically detect presence or absence of erroneous wiring in the encoder wiring line 42. Detection of presence or absence of the erroneous wiring is, for example, performed when the manipulator 30 is activated by the robot controller 10. Next, processing for detecting erroneous wiring in this embodiment will be described below with reference to FIG. 2. In this embodiment, mechanical parameters have been already stored in the storage part 33 when the manipulator 30 is assembled. The mechanical parameters are associated with each axis of the manipulator 30 and include a serial number (S/N) of the encoder 32 of each axis. In this embodiment, the serial number is used as identification information for uniquely discriminating the encoder 32. Identification information other than the serial number which is capable of discriminating the encoder 32 may be used.

First, in the step 101, the control part 12 activates the manipulator 30. As a technique that the robot controller 10 activates the manipulator 30, a widely known technique may be used. Successively, in the step 102, the control part 12 sequentially transmits a command requesting a serial number to the encoder 32 for each axis through the encoder wiring line 42 via the servo driver 11, and the control part 12 receives the serial number from the encoder 32 which has received the command via the servo driver 11. In the step 103, the control part 12 transmits a command, which requests a serial number of the encoder 32 for each axis in the mechanical parameters stored in the storage part 35, to the processing part 34 of the manipulator 30. The processing part 34 processes the command and transmits the serial number of the encoder 32 for each axis to the control part 12. The order of the processing in the step 102 and the processing in the step 103 may be reversed.

Next, in the step 104, the control part 12 compares the serial number read out from the encoder 32 via the servo driver 11 with the serial number in the mechanical parameters for each axis of the manipulator 30 and, in the step 105, the control part 12 discriminates whether the serial number read out from the encoder 32 and the serial number in the mechanical parameters are coincided with each other or not for all axes. The serial number for each axis included in the mechanical parameters correctly indicates the serial number stored in the encoder 32 which is provided in the each axis of the manipulator 30. When erroneous wiring does not occur, the serial number read out from the encoder 32 and the serial number included in the mechanical parameters must coincide with each other for each axis. Therefore, when both the serial numbers are coincided with each other in all the axes in the step 105, the control part 12 determines that erroneous wiring in the encoder wiring line 42 does not occur and, in the step 106, the control part 12 starts control of the manipulator 30 based on previously determined operation program, and the processing for detecting erroneous wiring is finished.

On the other hand, if there exists erroneous wiring in the encoder wirings line 42, a connecting relationship of the encoder 32 with the robot controller 10 is different from an intended connection and thus, an axis exists whose serial number read out from the encoder 32 is not coincided with the serial number included in the mechanical parameters. When at least one of the axes whose serial numbers are not coincided with each other exists in the step 105, the control part 12 determines that there is erroneous wiring in the step 107 and outputs an alarm, for example. Further, the axis whose serial numbers are not coincided with each other is the axis corresponding to the erroneous wiring and thus, in the step 108, the control part 12 indicates the axis corresponding to the erroneous wiring, for example, on a software tool of the robot controller 10 or on a pendant connected with the robot controller 10 as information for identifying the erroneous wiring portion and, after that, processing for detecting erroneous wiring is finished.

In the robot system in accordance with this embodiment, erroneous wiring in the encoder wiring lines 42 can be detected without actually operating the motors 31 of the manipulator 30. Specifically, since erroneous wiring is detected when the manipulator 30 is activated, presence or absence of erroneous wiring is recognized before the robot controller 10 actually operates the manipulator 30. Therefore, the manipulator 30 is not driven at a time of abnormality and thus, occurrence of malfunction in the manipulator is suppressed and safety is improved. Further, when it is determined that erroneous wiring has occurred, information for identifying the erroneous wiring portion is outputted and thus, a load of work for disassembling the manipulator 30 and searching the actual erroneous wiring portion can be remarkably reduced.

In the robot system described above, the mechanical parameters previously stored in the storage part 35 of the manipulator 30 include a serial number of the encoder 32 for each axis. However, the mechanical parameters may include other information in addition to a serial number of the encoder 32. For example, it may be configured that configuration information relating to structure of the manipulator 30 is included in mechanical parameters, and the manipulator 30 is controlled based on the configuration information extracted from the mechanical parameters which are read out from the manipulator 30 by the robot controller 10. Next, an embodiment of a case in which configuration information of the manipulator 30 is included in mechanical parameters will be described below.

When operation of the manipulator 30 is to be controlled by the robot controller 10, the operation is required to control based on information such as an axis configuration of the manipulator 30, lengths of an arm and a link, an operating range where the arm and the link are permitted to be moved in a space in which the manipulator 30 is installed, and an allowed maximum-speed. Such information which is required to control operation of the manipulator 30 is referred to as configuration information of the manipulator 30. Conventionally, such configuration information is required to previously store in the robot controller 10 and thus, when the robot controller 10 connected with the manipulator 30 is changed due to occurrence of malfunction in the robot controller 10, it is difficult to operate the robot system immediately. On the other hand, in this embodiment, configuration information of the manipulator 30 is included in mechanical parameters which are stored in the storage part 35 of the manipulator 30, and the robot controller 10 read outs the mechanical parameters to control the manipulator 30 based on the configuration information in the mechanical parameters. According to this embodiment, even in a case that configuration information is not previously stored in the robot controller 10, when the robot controller 10 connected with the manipulator 30 is changed, the robot system can be immediately operated.

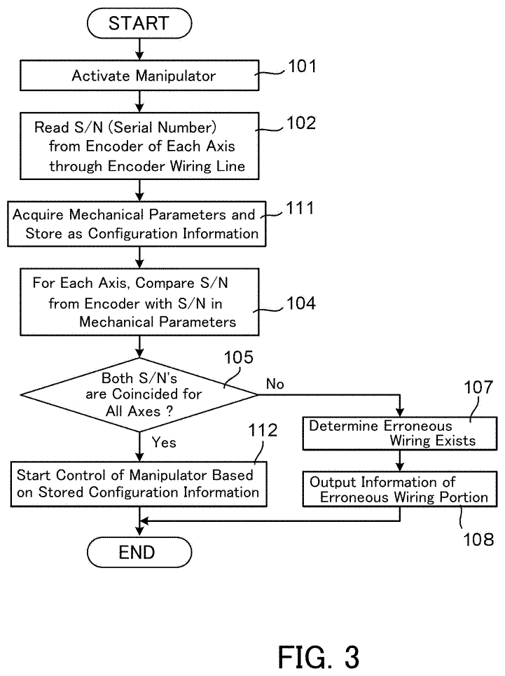

FIG. 3 is a flow chart showing processing for detecting erroneous wiring in a case that mechanical parameters including configuration information of the manipulator 30 are previously stored in the storage part 35 of the manipulator 30. In FIG. 3, the same processing as the processing in the flow chart shown in FIG. 2 is indicated with the same reference sign. First, similarly to the case shown in FIG. 2, the control part 12 activates the manipulator 30 in the step 101 and, in the step 102, the control part 12 reads out a serial number of the encoder 32 from the encoder 32 for each axis through the encoder wiring line 42 via the servo driver 11. Successively, in the step 111, the control part 12 transmits a command requesting mechanical parameters stored in the storage part 35 to the processing part 34 of the manipulator 30. The processing part 34 processes the command to read out the mechanical parameters from the storage part 35 and transmit them to the control part 12. As a result, the control part 12 acquires the mechanical parameters and stores them in a storage area (not shown) in the robot controller 10 as configuration information. The order of the processing in the step 102 and the processing in the step 111 may be reversed.

Next, similarly to the case shown in FIG. 2, the control part 12 compares the serial number read out from the encoder 32 with the serial number in the mechanical parameters for each axis of the manipulator 30 and, in the step 105, the control part 12 discriminates whether the serial number read out from the encoder 32 and the serial number in the mechanical parameters are coincided with each other or not for all axes. When both the serial numbers are coincided with each other in all the axes in the step 105, the control part 12 determines that erroneous wiring does not exist in the encoder wiring line 42 and, in the step 112, the control part 12 starts control of the manipulator 30 based on the configuration information stored in the storage area, and the processing for detecting erroneous wiring is finished.

On the other hand, when at least one of the axes whose serial numbers are not coincided with each other exists in the step 105, similarly to the case shown in FIG. 2, the control part 12 determines that there is erroneous wiring in the step 107 and, in the step 108, the control part 12 outputs information for identifying an erroneous wiring portion, and the processing for detecting erroneous wiring is finished

As described above, according to this embodiment, configuration information of the manipulator 30 is stored in the storage part 35 of the manipulator 30, and the robot controller 10 is capable of reading out the configuration information of the manipulator 30. Therefore, even in a case that the robot controller 10 is replaced due to, for example, malfunction, erroneous wiring in the encoder wiring line 42 of the manipulator 30 can be detected and the robot system is capable of immediately functioning.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A robot system comprising:
a manipulator which comprises a plurality of axes and is driven by motors provided for each of the axes;
a robot controller which controls the manipulator;
an encoder which is attached to the motor for each of the axes;
an encoder wiring line which is provided for each of the axes and connects the encoder with the robot controller;
a storage part which is independently provided in the manipulator from the encoder and stores mechanical parameters including at least identification information for discriminating the encoder for each of the axes of the manipulator; and
a control part which is provided in the robot controller and reads out the mechanical parameters from the storage part and communicates with the encoder through the encoder wiring line;
wherein the control part discriminates whether the identification information read out from the encoder through the encoder wiring line for discriminating the encoder and the identification information included in the mechanical parameters are coincided with each other or not for each of the axes; and
wherein when both the identification informations are not coincided with each other in at least one of the axes, the control part determines that erroneous wiring exists in the encoder wiring line.

2. The robot system according to claim 1, wherein the control part outputs information which identifies the encoder wiring line where the erroneous wiring has occurred based on an axis in which the identification information read out from the encoder and the identification information included in the mechanical parameters are not coincided with each other.

3. The robot system according to claim 2, wherein
the mechanical parameters include configuration information relating to structure of the manipulator, and
the robot controller controls the manipulator based on the configuration information extracted from the mechanical parameters which are read out by the control part.

4. The robot system according to claim 1, wherein
the mechanical parameters include configuration information relating to structure of the manipulator, and
the robot controller controls the manipulator based on the configuration information extracted from the mechanical parameters which are read out by the control part.

5. An erroneous wiring detection method of a robot system, the robot system comprising:
a manipulator which comprises a plurality of axes and is driven by motors provided for each of the axes;
a robot controller which controls the manipulator; and
an encoder which is attached to the motor for each of the axes;
the erroneous wiring detection method being a method for detecting erroneous wiring in an encoder wiring line which is provided for each of the axes and connects the encoder with the robot controller, comprising:
a storing step in which mechanical parameters including at least identification information for discriminating the encoder for each of the axes of the manipulator are previously stored in a storage part independently provided in the manipulator from the encoder;
a discrimination step in which, in the robot controller, the identification information for discriminating the encoder is read out from the encoder of each of the axes through the encoder wiring line and the mechanical parameters are read out from the storage part to discriminate whether the identification information which is read out from the encoder and the identification information included in the mechanical parameters are coincided with each other or not for each of the axes; and
an erroneous wiring detection step in which, both the identification informations are not coincided with each other in at least one of the axes in the discrimination step, it is determined that erroneous wiring exists in the encoder wiring line.

6. The erroneous wiring detection method according to claim 5, wherein in the erroneous wiring detection step, information for identifying the encoder wiring line where the erroneous wiring has occurred is outputted based on an axis in which the identification information read out from the encoder and the identification information included in the mechanical parameters are not coincided with each other.

7. The erroneous wiring detection method according to claim 6, wherein the discrimination step and the erroneous wiring detection step are executed when the robot controller activates the manipulator.

8. The erroneous wiring detection method according to claim 5, wherein the discrimination step and the erroneous wiring detection step are executed when the robot controller activates the manipulator.

9. The erroneous wiring detection method according to claim 7, wherein
the mechanical parameters include configuration information relating to configuration of the manipulator, and
the configuration information extracted from the mechanical parameters is set to be configuration information which is used when the robot controller controls the manipulator.

10. The erroneous wiring detection method according to claim 8, wherein
the mechanical parameters include configuration information relating to configuration of the manipulator, and
the configuration information extracted from the mechanical parameters is set to be configuration information which is used when the robot controller controls the manipulator.
